(19) United States
(12) Patent Application Publication
(10) Pub. No.: US 2012/0328132 A1
(43) Pub. Date: Dec. 27, 2012

(54) Perforated Miniature Silicon Microphone

(76) Inventor: Yunlong Wang, San Ramon, CA (US)

(21) Appl. No.: 13/169,065

(22) Filed: Jun. 27, 2011

(51) Int. Cl. H04R 17/02

(52) U.S. Cl. 381/174

(57) ABSTRACT

This invention relates to a miniature silicon capacitive microphone having a perforated backplate supported on a substrate, a shallowly corrugated and perforated diaphragm that is suspended above said backplate and said suspended shallowly corrugated and perforated diaphragm is fully clamped and anchored on the said substrate at the edge of said diaphragm. Said perforated backplate is isolated electrically from said substrate by a layer of dielectric material. Said suspended shallowly corrugated diaphragm has a plurality of perforation holes to allow the passage of slow varying ambient pressure, and to equalize the barometric pressure in and out of the back cavity.

### CROSS REFERENCE TO RELATED APPLICATION

U.S. Pat. Nos. 5,146,435; 5,452,268; 6,535,460; 6,847,090; 6,870,937; 6,945,115; 7,152,481; 7,329,933; 7,346,178; US 2006/0280319.

### BACKGROUND OF THE INVENTION

Silicon capacitive microphone has been an attractive topic for many publications and disclosures. The batch processing of micromachining enables the production of these microphones to be made inexpensively and in large quantity. Compared with traditional capacitive microphones, silicon capacitive microphones offer a much larger set of parameters for optimization as well as ease for on-chip electronic integration.

In many publications such as U.S. Pat. Nos. 5,146,435; 5,452,268; 6,847,090; and 6,870,937, the movable diaphragm of a silicon capacitive microphone is either supported by a substrate or insulative supports such as silicon nitride, silicon oxide and polyimide. The supports engage the edge of the diaphragm, and a voltage is applied between the substrate and the surface of the diaphragm causing the diaphragm to be biased and vibrate in response to the passing sound waves. In one particular case as described in the U.S. Pat. No. 6,535,460, the diaphragm is suspended to allow it rest freely on the support rings. U.S. Pat. No. 7,329,933 to Wang et al describes a microphone sensing element and a method for making the same. The sensing element has a diaphragm and an attached electrical lead-out arm preferably made of polysilicon that are separated by an air gap from an underlying backplate region created on a conductive silicon substrate. The backplate region has acoustic holes created by removing an oxide filling in a continuous trench that surrounds hole edges and by removing oxide to form the air gap. The diaphragm is softly constrained along its edge by an elastic element that connects to a surrounding rigid polysilicon layer. The elastic element is typically a polymer such as parylene having a Young's modulus substantially less than that of the diaphragm. First and second electrodes are connected to the diaphragm through the lead-out arm and to the substrate through polysilicon via fillings, respectively, and thereby establish a variable capacitor circuit for acoustic sensing.

A good microphone is considered to have a nearly flat frequency response across the audio range that it operates, that is, from 20 Hz to 20 kHz. It also needs to have high signal to noise ratio such that electronic devices equipped with the microphone can work in a noisy environment. The high signal to noise ratio is usually achieved by making the microphone have high enough intrinsic sensitivity, which implies that diaphragm of the microphone must be sufficiently compliant such that it can sense the small acoustic pressure fluctuation. However, achieving a large dynamic range and a high sensitivity can be conflicting goals, since large sound pressures may cause a diaphragm to collapse under its voltage bias if it is very compliant. For Silicon capacitive microphones, the sensitivity is mainly affected by the intrinsic stress in the diaphragm given the size and thickness of diaphragm are fixed. Since intrinsic stress is resulted from the process, the stress releasing and control technique is vital in achieving good Silicon capacitive microphones.

One commonly used stress releasing technique is to form corrugations in the diaphragm. The corrugated diaphragm is capable of releasing the built-in stress during the processing, thereby increasing the mechanical sensitivity of the diaphragm and reducing the irreproducibility. Compared with the conventional flat diaphragm, the corrugated diaphragm has an increased sensitivity, especially for the case of high residual stress level.

A good microphone also needs to work in an environment that may be filled with dusts and/or micro-particles that can fall onto the diaphragm surface. These dusts and/or particles may be small enough that will not cause the catastrophic failure of the microphone. They, however, will certainly result in the performance degradation. One reason for such degradation is that these dusts will act as added mass on the diaphragm, causing the diaphragm less compliant and therefore less sensitive to the sound. The dust particles may also be trapped in the air gap between the diaphragm and the backplate, making the diaphragm stiffer, and thus the microphone less sensitive.

In practice, the diaphragm of a silicon microphone will need to be made rugged enough to pass the reliability tests. This ruggedness requirement may result in the low intrinsic sensitivity of microphone, and thus a signal conditioning and amplification circuit is used to couple with the silicon sensing element. For a silicon condenser microphone, the capacitance variation resulted from the diaphragm vibration under the sound pressure is the driving element for the sound pickup. This is the raw sensitivity of the microphone. Ideally, this raw signal should be conditioned and amplified through the electronic circuit without any loss. In reality, though, there are parasitics associated with the silicon sensing element. The parasitics will act as voltage divider to lower the raw sensitivity of the microphone, thus requiring more amplification from the electronic circuit, and lowering the signal to noise ratio of the microphone. It is therefore important that silicon sensing element be made with minimal parasitics.

In micromachining, residual stress is inevitable in deposited films such as silicon nitride, polysilicon, and polyimide. And therefore, it is of great importance to develop a technique to release residual stress in the diaphragm film while maintaining its mechanical strength. It is also important in silicon microphone manufacturing that the fabrication process is simple and robust.

### OBJECTS AND SUMMARY OF THE INVENTION

It is an object of the present invention to provide a miniature silicon capacitive microphone having wide and flat frequency response and high signal to noise ratio.

It is a further object of the present invention to provide a miniature silicon capacitive microphone that comprises a perforated back plate supported on a substrate.

It is another object of the present invention to provide a miniature silicon capacitive microphone that has shallowly corrugated diaphragm.

It is a further object of the present invention to provide a miniature silicon capacitive microphone whose shallowly corrugated diaphragm is also perforated.

It is another object of the present invention to provide a miniature silicon capacitive microphone whose shallowly corrugated and perforated diaphragm is fully clamped and anchored at the edge on the backplate or substrate.

It is a further object of the present invention to provide a miniature silicon capacitive microphone whose perforated backplate is electrically isolated from the supporting substrate.

It is another object of the present invention to provide a miniature silicon capacitive microphone that has the reduced parasitics.

The foregoing and other objects of the invention are achieved by a miniature silicon capacitive microphone including a perforated backplate supported on a substrate, a shallowly corrugated and perforated diaphragm that is suspended above said backplate and said suspended shallowly corrugated and perforated diaphragm is fully clamped and anchored on said substrate at the edge of said diaphragm. The said perforated backplate is isolated electrically from the said substrate by a layer of dielectric material. The said suspended shallowly corrugated diaphragm has a plurality of acoustic holes to allow the passage of slow varying ambient pressure, and to equalize the barometric pressure in and out of the back cavity. Each perforated diaphragm itself supports a conductive electrode for movement therewith, whereby each perforated backplate forms a capacitor with the said perforated diaphragm. The capacitance of the said capacitor varies with movement of the diaphragm in response to the passing acoustic wave. Conductive lines interconnect said conductive electrodes to provide output signals.

### BRIEF DESCRIPTION OF THE DRAWINGS

The foregoing and other objects of the invention will be more clearly understood from the following description when read in conjunction with the accompanying drawings of which:

FIG. 1 is a cross-sectional view of a generic silicon microphone for illustrating the fluid mechanics of determining the low frequency cut-off.

FIG. 2 is a simulation result showing the low frequency roll-off of a silicon microphone.

FIG. 3 is a simulation result showing the improved low frequency response of a silicon microphone.

FIG. 4 is a cross-sectional view of a miniature silicon capacitive microphone with a shallowly corrugated and perforated diaphragm and perforated backplate along the line A-A′ in FIG. 5 according to one preferred embodiment of the present invention.

FIG. 5 shows a top plan view of a miniature silicon capacitive microphone according to one preferred embodiment of the present invention.

FIG. 6 shows an expanded view of metal contact region of a miniature silicon capacitive microphone according to one preferred embodiment of the present invention.

FIG. 7 shows a cross-sectional view of a miniature silicon capacitive microphone along the line A-A′ in FIG. 4 according to another preferred embodiment of the present invention.

FIG. 8 shows a top plane view of a miniature silicon capacitive microphone according to another preferred embodiment of the present invention.

### DESCRIPTION OF THE PREFERRED EMBODIMENTS

For silicon capacitive microphones, its sensitivity is largely dominated by the intrinsic stress of diaphragm. When the size of the diaphragm is fixed, its mechanical sensitivity is inversely proportional to the intrinsic stress in the diaphragm. A diaphragm has the highest mechanical sensitivity when it is free to move in a plane that is perpendicular to its own plane as a piston. On the other hand, certain level of intrinsic stress needs to be maintained in the diaphragm such that its resonant frequency is far from the frequency range it operates, thereby exhibiting a flat frequency response in the audio frequency range. In addition, the mechanical strength of the diaphragm also requires the diaphragm to be stiffer. These seemed conflicting requirements suggest that a silicon capacitive microphone needs to have ways to tightly control its intrinsic stress to meet the final product requirements. One technique to release or control the intrinsic stress in the diaphragm is to develop a costly micromachining recipe. But such technique suffers from transportability between different foundries as they tend to have different capabilities.

The bandwidth of a microphone also depends on the lower cut-off frequency. The lower cut-off frequency is caused by the air in a confined cavity. For instance, the narrow air-gap between diaphragm and backplate, and back chamber. A pressure equalization vent is needed to equalize very slow variations in atmospheric pressure (low frequencies) to prevent the diaphragm from snap down to the backplate. Therefore, a low-frequency mechanical roll-off in the membrane response is resulted. The equalization vent prevents many silicon microphones from sensing below 100 Hz. To keep the low frequency cut-off as low as possible the size and shape of the static pressure equalization vent and acoustic holes must be carefully designed.

In US publication 2006/0280319, it describes a micromachined capacitive microphone having a shallowly corrugated diaphragm that is anchored at one or more locations on the support has a plurality of dimples to support itself and rest freely on the perforated backplate. The diaphragm whose ends are not anchored is bounded by the taps of edge rail. Also disclosed includes: a fixed perforated backplate having one or more regions; an adjustable cantilever formed by the diaphragm, the support and the backplate; a plurality of dimples maintaining vertical separation between diaphragm and backplate; and the patterning of conductor electrodes carried by diaphragm and backplate.

In U.S. Pat. No. 6,870,939, An electroacoustic transducer is described which comprises a lower electrode; an upper electrode including an oscillation portion and a support portion for supporting the oscillation portion at least at a part of a periphery of the oscillation portion; and an insulating layer for insulating the lower electrode from the upper electrode, wherein the upper electrode has an up and down in the oscillation portion and/or in the support portion to provide a cavity between the upper electrode and the lower electrode.

In these publications, the silicon microphone has a diaphragm that is either not perforated or only has ventilation holes along the edge of the diaphragm. The ventilation holes are used to equalize the pressure in and outside the back chamber.

In other publications, such as U.S. Pat. No. 7,346,178 to Wang, et al, however, it describes a silicon based microphone sensing element. The microphone sensing element has a diaphragm with a perforated plate adjoining each side or corner. The diaphragm is aligned above one or more back holes created in a conductive substrate wherein the back hole has a width less than that of the diaphragm. Perforated plates are suspended above an air gap that overlies the substrate. The diaphragm is supported by mechanical springs with two ends that are attached to the diaphragm at a corner, side, or center and terminate in a rigid pad anchored on a dielectric spacer layer. A first electrode is formed on one or more rigid pads and a second electrode is formed at one or more locations on the substrate to establish a variable capacitor circuit. The microphone sensing element can be embodied in different approaches to reduce parasitic capacitance. In this particular example, a perforated diaphragm is suspended above a conductive substrate having a cavity formed by the etch on the substrate.

We approach the design of a miniature silicon microphone by first looking at the fluid mechanics theory. We realize that the lowest frequency to which a microphone responds is largely dependent on the size of the static-pressure equalization vent whose purpose is to prevent the diaphragm from bulging if there is a change in atmospheric pressure. At most frequencies in the audio range the vent is small enough for its air resistance to prevent sound waves from entering the microphone's internal cavity. However, at lower frequencies a small proportion of sound waves acting on the vent do enter the cavity. The low-frequency sound in the cavity then starts to oppose the motion of the diaphragm and the microphone's frequency-response curve ‘tails-off’ and its phase response changes.

The microphone ceases to respond altogether when the instantaneous low-frequency sound pressure is the same on both sides of the diaphragm (because there must be a pressure difference across the diaphragm to make it move).

From the fluid mechanics theory, the vent used to equilibrate the vent to the ambient pressure will possess an effective mass of:

$$M = \frac{16 ρ L}{3 π {D}^{2}}$$

Where L is the effective vent length, and D is the hydraulic diameter of the vent. The vent also dissipates acoustic energy via friction, and thus possesses an effective resistance:

$$R = \frac{128 μ L}{π {D}^{4}}$$

Where, μ is the viscosity of the air. The effective length of the vent is calculated by using friction factors for straight sections and empirical relationships for bends that enhance dissipation via secondary flow-based mixing.

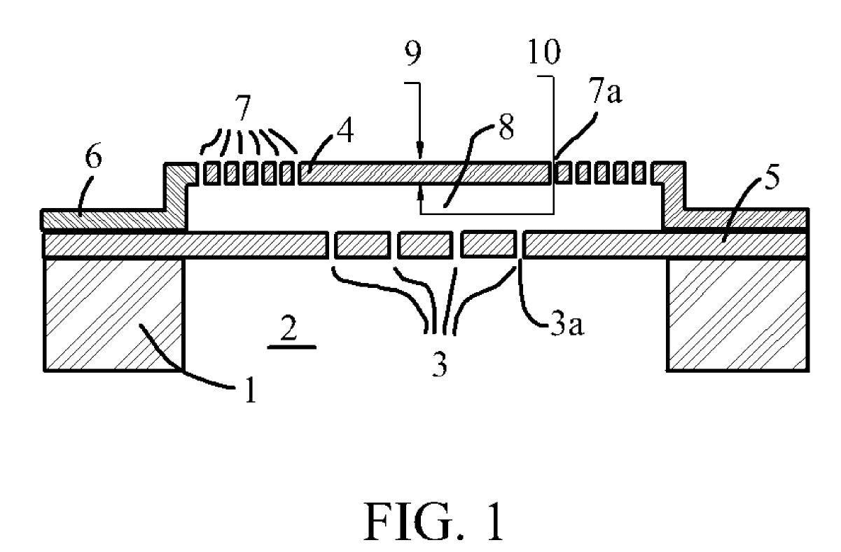

We now refer to the FIG. 1. This figure shows a generic cross sectional view of a silicon microphone with a backplate 5 supported by substrate 1. A diaphragm 4 is anchored on the backplate 5 at positions 6. The diaphragm 4 has ventilation holes 7, and is suspended above the backplate 5. The diaphragm 4 and backplate 5 form an air gap 8. The backplate 5 also has perforation holes 3. The back chamber 2 is formed by etching away bulk silicon from substrate 1.

We assume the back chamber 2 is completely sealed by attaching the silicon microphone die to PCB board by adhesive. When a sound pressure wave 9 is impinging on the diaphragm 4, the main leakage paths for the pressure wave 9 would be through the ventilation holes 7 on the diaphragm, and then through the air gap 8, and finally through the back side of diaphragm 4, as shown by the path 10. At low frequency, the pressure wave 9 that leaked through will oppose the deflection of the diaphragm 4, and hence reduce the sensitivity of the microphone.

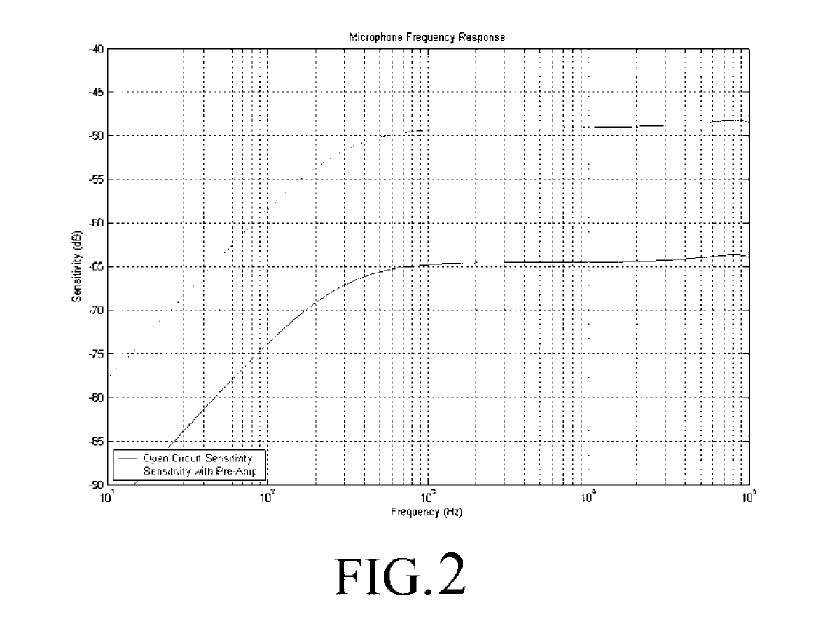

The leakage path 10 through the ventilation holes 7 will also cause the low frequency roll-off on the microphone response curve, as shown in FIG. 2. As we can see from this case, the microphone response rolls off from 600 Hz, which is not the desired response that we sought.

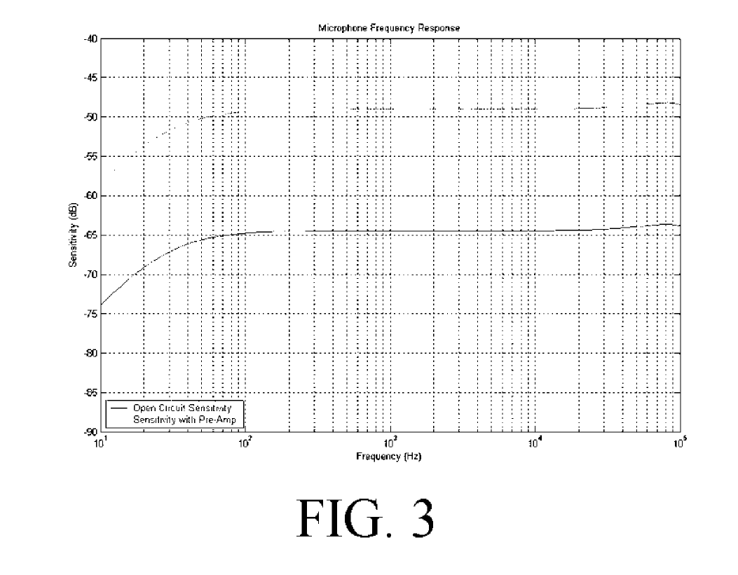

We denote the ventilation hole that is closest to the center of diaphragm 4 as 7a. Similarly, we denote the perforated hole on the backplate 5 that is the closest to the edge of cavity 2 as 3a, as shown in FIG. 1. The acoustic leakage path thus formed from 7a to 3a determines the low frequency response of a silicon microphone. FIG. 3 shows a typical silicon microphone response when the effective vent path is increased to 50 um. In this case, the microphone has a nearly flat frequency response down to 70 Hz.

Since the effective resistance of acoustic energy is inversely proportional to the 4^{th} power of vent diameter, the size of vent holes 7 plays an important roles in determining the low frequency response of a silicon microphone. And hence, according to one preferred embodiment of present invention, the ventilation holes 7 are designed to be less than 3 um in diameter, and are manufactured with photolithography process.

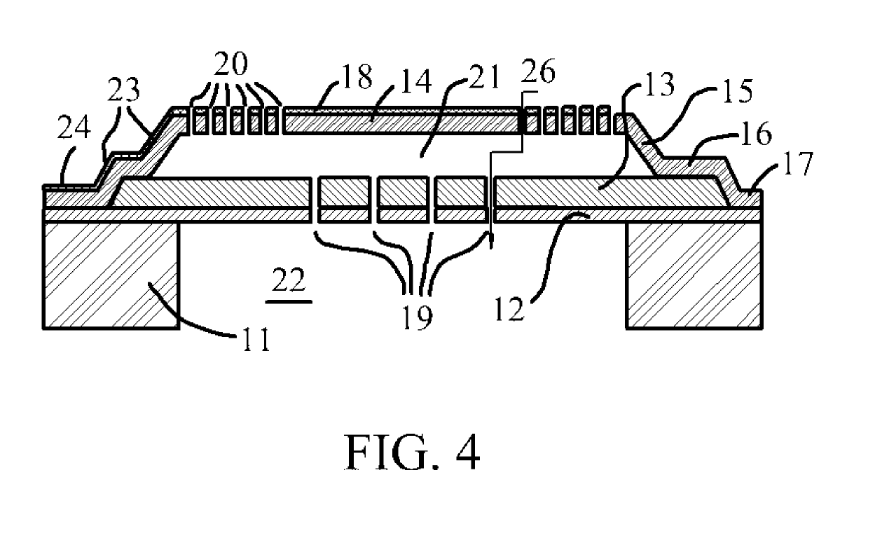

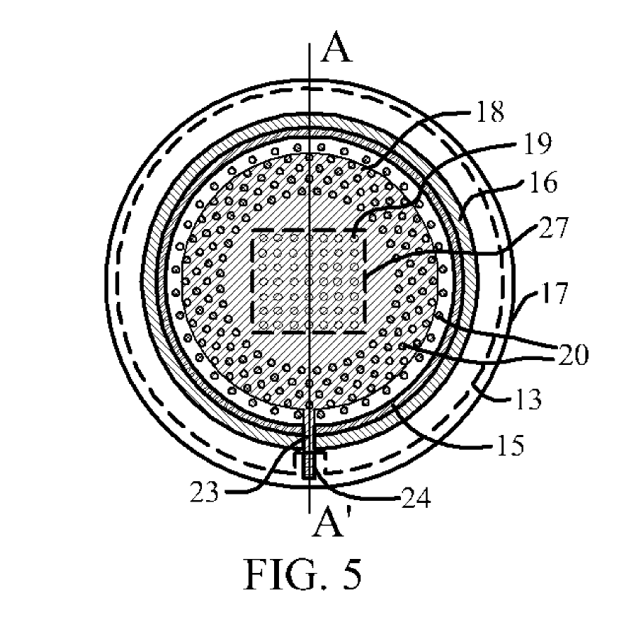

Referring to FIG. 4 now. This figure shows the cross sectional view along line A-A′ of a miniature silicon microphone in FIG. 5 manufactured according to one preferred embodiment of the present invention. The miniature silicon microphone is built on a silicon substrate 11, which supports a conductive backplate 13. A dielectric layer 12 is inserted between the substrate 11 and conductive backplate 13, such that it isolates electrically the conductive backplate 13 from the silicon substrate 11. The conductive backplate 13 has perforated acoustic holes 19 at the center of cavity 22 that is formed by etching away the bulk silicon material on the silicon substrate 11. The diaphragm 14 is suspended above the conductive backplate 13, and maintains an air gap 21 from the backplate 13. The diaphragm 14 is also perforated, and has perforation holes 20. The diaphragm 14 is formed by depositing a non-conductive material, such as silicon nitride, polyimide, or undoped polysilicon. A conductive thin film 18 is thus deposited on top of the diaphragm 14 to form another electrode of a capacitor so formed by the conductive backplate 13 and the conductive thin film 18.

The diaphragm 14 is shallowly corrugated at the edge to form a shallow corrugation 15, and is fully clamped and anchored at the perimeter 16 on the conductive backplate 13. The diaphragm 14 is further anchored to the dielectric layer 12 at the edge 17. Conductive thin film 18 forms an electrode lead 23 along the shallow corrugation 15 of diaphragm 14, and a bonding pad 24 at the edge 17 of the diaphragm 14.

When an acoustic pressure wave, such as that formed by a speech signal, is impinging upon the diaphragm 14, it will deflect, and cause the air gap 21 to change. Thus, the capacitance of the capacitor so formed by the diaphragm 14 and conductive backplate 13 fluctuates, reflecting the acoustic signal variation. Pressure ventilation passage 26 is formed between the perforation holes 20 on diaphragm 14 and perforation holes 19 on the backplate 13. This passage is to equilibrate the pressure inside the back chamber 22 to the ambient pressure. According to one preferred embodiment of present invention, the pressure ventilation passage 26 is longer than on the order of 50 um to 100 um. Depending on the size of air gap 21, pressure ventilation passage 26 can be longer than 100 um to achieve the flat frequency response at low frequency.

FIG. 5 shows the top plan view of a miniature silicon microphone according to one preferred embodiment of present invention. The perforation holes 20 are randomly or even spaced on diaphragm 14 between the edge of cavity 27 and the shallow corrugation 15. Cavity edge 27 is where the back chamber 22 meets the backplate 13, and is formed by the etching of bulk silicon substrate. Perforation holes 19 on backplate 13 can also be arranged uniformly or randomly. Perforation holes 19 and perforation holes 20 can have the same size, but in most of cases, they have different diameters. Perforation holes 20, for example, usually have diameters around 1 to 3 um. The diameter of perforation holes 19 is typically around 10 to 15 um. Perforation holes 20 are arranged in such a way that their centers do not go through the same radial line originated from the center of diaphragm 14. This type of arrangement helps reduce the intrinsic stress in the diaphragm 14, and thus help improve the raw sensitivity of the miniature silicon microphone manufactured according to the preferred embodiment of present invention.

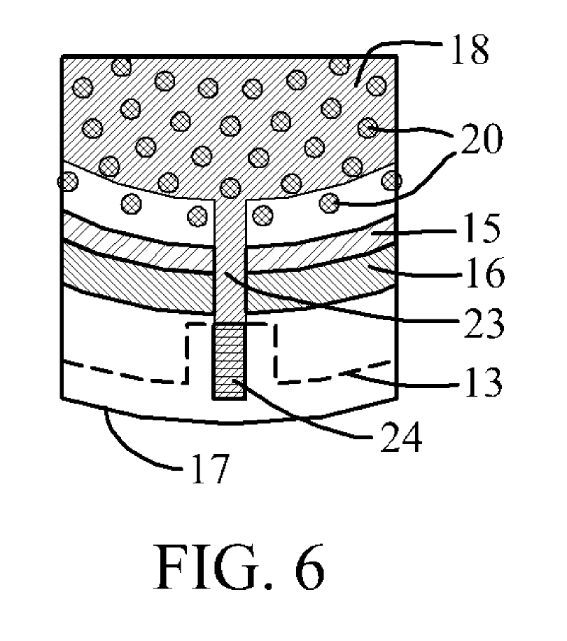

To help reduce the parasitic capacitance of the miniature microphone, a cut-out 28 is formed on the backplate 13 where the electrode lead 23 comes off the diaphragm 14, and thus the bonding pad 24 rests completely on top of the dielectric layer 12. Without the cut-out 28, the bonding pad 24 would be separated from the conductive backplate 13 by the diaphragm 14. Since the diaphragm 14 is usually on the order 1 um in thickness, a strong parasitic capacitance would then be formed by the bonding pad 24 and the backplate 13. The magnified view of this contact region of the miniature silicon microphone according to one preferred embodiment is shown in FIG. 6.

Referring again to FIG. 4. The conductive backplate 13 is separated from the substrate 11 by a dielectric layer 12. This dielectric layer 12 essentially isolates the backplate 13 electrically from the substrate 11. The substrate 11 is usually made from silicon type of material, and is a semiconductor. In packaging or real usage, the miniature silicon microphone manufactured according to one preferred embodiment of present invention is usually attached to a PCB board, thus sealing the back chamber 22. This also allows the substrate 11 to make contact with the ground electrode on the PCB board, thus making the substrate 11 to have essentially the same electrical potential as the ground electrode on the PCB board. The existence of the dielectric layer 12 isolates the backplate 13 from this ground electrical potential, and a capacitor is also formed between the backplate 13 and the substrate 11. Compared with the capacitor formed between the diaphragm 14 and backplate 13, the capacitance of the capacitor between substrate 11 and backplate 13 is larger since the thickness of dielectric layer 12 is typically on the order of submicron. Together with a high resistance of the semiconductor material of substrate 11, the capacitor formed by diaphragm 14 and backplate 13 operates in a float status. The backplate 13 thus can be viewed as a virtual ground when connected to the input of an ASIC.

In equivalent circuit, the capacitor formed between diaphragm 14 and backplate 13 is in serial connection with the capacitor formed by the backplate 13 and substrate 11. Since the capacitance of the second capacitor is much larger than the first capacitor, impact of second capacitor on the first capacitor can be largely ignored. And therefore, the sensitivity of the miniature silicon microphone manufactured according to one preferred embodiment of present invention is minimally affected by the electrical grounding of substrate 11. The electrical isolation of the capacitor formed by the diaphragm 14 and backplate 13 also ensures that the biasing polarity on the capacitor does not change the sensitivity of the microphone.

As discussed earlier, the flow resistance of pressure ventilation passage 26 includes the ventilation holes 20, air gap 21 and the acoustic holes 19 formed on backplate 13. Whereas ventilation holes 20 and air gap 21 play critical roles in stopping the acoustic pressure leakage through the ventilation holes 20. When the air gap 21 is smaller compared with the diameter of ventilation holes 20, the size of ventilation holes 20 becomes the deciding factor in controlling the low frequency roll-off of the silicon microphone manufactured according to preferred embodiments of present invention. On the other hand, when the air gap 21 is larger compared with the size of ventilation holes 20, it becomes the dominant factor in determining the low frequency response of the silicon microphone.

In design, the height of air gap 21 is determined by considering in combination of bias voltage, sensitivity, and the acoustic noise requirement of a silicon microphone. The bias voltage, sensitivity and acoustic noise are competing requirements. For example, reducing the height of air gap 21 will increase the microphone sensitivity, but it lowers the pull-in voltage and thus reduces the bias voltage the microphone can operate, and eventually will also lower the microphone sensitivity in the end. When a premium height of air gap 21 is chosen by considering all these competing requirements, it might be larger than the size of pressure ventilation holes 20. And thus, it becomes the primary target that affects the low frequency response of the silicon microphone.

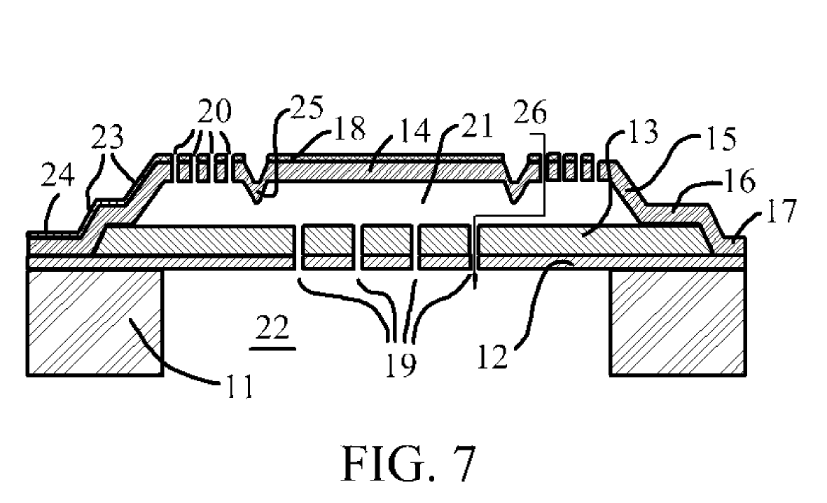

Refer to FIG. 7 now. This figure shows the cross sectional view of a miniature silicon microphone manufactured according to another preferred embodiment of present invention. The miniature silicon microphone is built on a silicon substrate 11, which supports a conductive backplate 13. A dielectric layer 12 is inserted between the substrate 11 and conductive backplate 13, such that it isolates electrically the conductive backplate 13 from the silicon substrate 11. The conductive backplate 13 has perforated acoustic holes 19 at the center of cavity 22 that is formed by etching away the bulk silicon material on the silicon substrate 11. The diaphragm 14 is suspended above the conductive backplate 13, and maintains an air gap 21 from the backplate 13. The diaphragm 14 is also perforated, and has perforation holes 20. The diaphragm 14 is formed by depositing a non-conductive material, such as silicon nitride, polyimide, or undoped polysilicon. A conductive thin film 18 is thus deposited on top of the diaphragm 14 to form another electrode of a capacitor so formed by the conductive backplate 13 and the conductive thin film 18.

The diaphragm 14 is shallowly corrugated at the edge to form a shallow corrugation 15, and is fully clamped and anchored at the perimeter 16 on the conductive backplate 13. The diaphragm 14 is further anchored to the dielectric layer 12 at the edge 17. Conductive thin film 18 forms an electrode lead 23 along the shallow corrugation 15 of diaphragm 14, and a bonding pad 24 at the edge 17 of the diaphragm 14. In addition, the diaphragm 14 also have a V-shaped annular ring 25 formed between its perforated portion towards the edge and the un-perforated center portion. The depth of this V-shaped annular ring 25 is usually about ⅔ that of the height of the air gap 21, thus leaving the gap between the bottom of V-shaped annular ring 25 and backplate 13 at 0.5 um to 2 um. This narrower gap effectively increases the flow resistance, and therefore reduces the pressure leakage due to larger air gap 21.

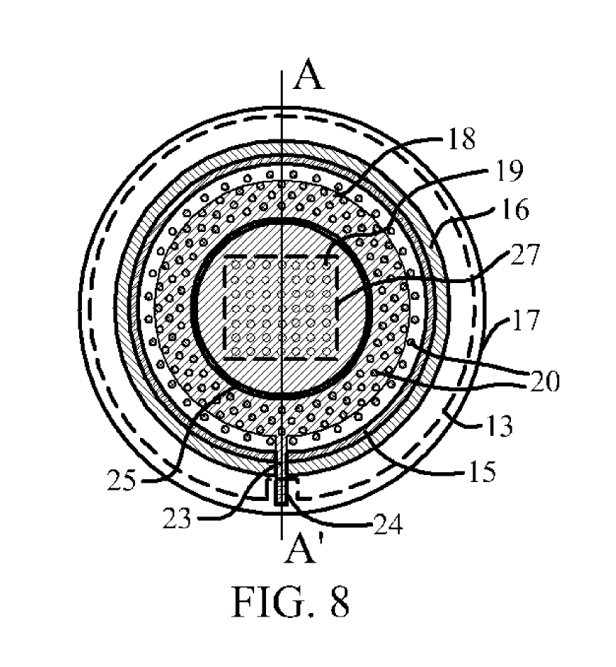

FIG. 8 shows the top plan view of a miniature silicon microphone according to another preferred embodiment of present invention. The perforation holes 20 are randomly or even spaced on diaphragm 14 between the edge of cavity 27 and the shallow corrugation 15. Cavity edge 27 is where the back chamber 22 meets the backplate 13, and is formed by the etching of bulk silicon substrate. Perforation holes 19 on backplate 13 can also be arranged uniformly or randomly. Perforation holes 19 and perforation holes 20 can have the same size, but in most of cases, they have different diameters. Perforation holes 20, for example, usually have diameters around 1 to 3 um. The diameter of perforation holes 19 is typically around 10 to 15 um. Perforation holes 20 are arranged in such a way that their centers do not go through the same radial line originated from the center of diaphragm 14. This type of arrangement helps reduce the intrinsic stress in the diaphragm 14, and thus help improve the raw sensitivity of the miniature silicon microphone manufactured according to the preferred embodiment of present invention. On diaphragm 14, V-shaped annular ring 25 is formed between diaphragm 14's perforated portion towards the edge and the un-perforated center portion.

The foregoing descriptions of specific embodiments of the present invention are presented for the purposes of illustration and description. They are not intended to be exhaustive or to limit the invention to the precise forms disclosed; obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A miniature silicon capacitive microphone comprising
a shallowly corrugated diaphragm having a plurality of perforation holes;
a backplate having a plurality of perforation holes is spaced in parallel below said diaphragm;
a substrate supporting said backplate and said diaphragm; and
a dielectric layer between said perforated backplate and said substrate.

2. A miniature silicon capacitive microphone of claim 1 in which said diaphragm is anchored at the edge on said substrate.

3. A miniature silicon capacitive microphone of claim 1 in which said diaphragm having a plurality of perforation holes and said perforated backplate having a plurality of perforation holes that are arranged in combination to form a low-pass filter for passing slow varying ambient pressure.

4. A miniature silicon capacitive microphone of claim 1 in which said diaphragm having a plurality of perforation holes supports conductive thin film for forming an electrode of a capacitor with said backplate.

5. A miniature silicon capacitive microphone of claim 1 in which said perforated backplate has a cut-out.

6. A miniature silicon capacitive microphone of claim 1 in which said conductive thin film supported on said diaphragm rests directly on said substrate at said cut-out of said backplate.

7. A miniature silicon capacitive microphone comprising
a shallowly corrugated diaphragm having a plurality of perforation holes;
a backplate having a plurality of perforation holes is spaced in parallel below said diaphragm;
a substrate supporting said backplate and said diaphragm;
a dielectric layer between said perforated backplate and said substrate; and
an annular ring separates the perforated portion and imperforated portion of said diaphragm.

8. A miniature silicon capacitive microphone of claim 7 in which said diaphragm is anchored at the edge on said substrate.

9. A miniature silicon capacitive microphone of claim 7 in which said diaphragm having a plurality of perforation holes and said perforated backplate having a plurality of perforation holes that are arranged in combination to form a low-pass filter for passing slow varying ambient pressure.

10. A miniature silicon capacitive microphone of claim 7 in which said diaphragm having a plurality of perforation holes supports conductive thin film for forming an electrode of a capacitor with said backplate.

11. A miniature silicon capacitive microphone of claim 7 in which said perforated backplate has a cut-out.

12. A miniature silicon capacitive microphone of claim 7 in which said conductive thin film supported on said diaphragm rests directly on said substrate at said cut-out of said backplate.
